(19) United States
(12) Patent Application Publication
(10) Pub. No.: US 2021/0192964 A1
(43) Pub. Date: Jun. 24, 2021

(54) ELECTRIC STORAGE AND ELECTRIC TAXIING SYSTEM FOR AN AIRCRAFT

(71) Applicant: The Boeing Company, Chicago, IL (US)

(72) Inventors: Bruce Van Deventer, Lynnwood, WA (US); Nima Forghani, Seattle, WA (US); Thomas R. Howard, Seattle, WA (US)

(21) Appl. No.: 16/719,841

(22) Filed: Dec. 18, 2019

(51) Int. Cl. G08G 5/06; B64C 25/40; B64D 27/24; B64D 41/00; B60L 50/60; G05D 1/02; B60L 7/10

(52) U.S. Cl. CPC G08G 5/06; B64C 25/405; B64D 27/24; B60L 2200/10; B60L 50/60; G05D 1/0202; B60L 7/10; B64D 41/00

(57) ABSTRACT

A taxiing system for an aircraft is presented. The taxiing system comprises energy storage locations electrically connected to a number of electric motors, the energy storage locations including at least two of a number of engines of the aircraft, a number of batteries, and a number auxiliary power units of the aircraft; and the number of electric motors connected to wheels of the aircraft to at least one of decelerate the wheels by transferring the kinetic energy of the aircraft into electric energy or drive the wheels using electric energy provided by at least one energy storage location of the energy storage locations.

### BACKGROUND INFORMATION

### 1. Field

The present disclosure relates generally to aircraft and, more specifically, to generation and use of electricity in an aircraft. The present disclosure relates to an electric taxiing system for an aircraft.

### 2. Background

While an aircraft is on the ground, movement of the aircraft is either performed by a tug or under the aircraft's own power. Towing and push-back of the aircraft is performed by a tug. Movement of the aircraft under its own power is called taxiing.

During taxi, the aircraft's engines generate more energy than is used to propel the aircraft. In some instances, an aircraft waits to approach a destination within an airport such as a runway or a gate. As an aircraft waits, the aircraft idles with its engines running.

Therefore, it would be desirable to have a method and apparatus that take into account at least some of the issues discussed above, as weil as other possible issues.

### SUMMARY

An illustrative embodiment of the present disclosure provides a taxiing system for an aircraft. The taxiing system comprises energy storage locations electrically connected to a number of electric motors, the energy storage locations including at least two of a number of engines of the aircraft, a number of batteries, and a number of auxiliary power units of the aircraft; and the number of electric motors connected to wheels of the aircraft to at least one decelerate the wheels by transferring the kinetic energy of the aircraft into electric energy or drive the wheels using electric energy provided by at least one energy storage location of the energy storage locations.

Another illustrative embodiment of the present disclosure provides an aircraft. The aircraft comprises carbon brakes, engines, landing gear having wheels, and a taxiing system configured to propel and decelerate motion of the aircraft. The taxiing system comprises energy storage locations electrically connected to a number of electric motors, the energy storage locations including at least two of a number of engines of the aircraft, a number of batteries, and a number of auxiliary power units, and the number of electric motors connected to wheels of the aircraft to at least one of decelerate the wheels by transferring the kinetic energy of the aircraft into electric energy or drive the wheels using electric energy provided by at least one energy storage location of the energy storage locations.

Yet another illustrative embodiment of the present disclosure provides a method of taxiing an aircraft. Electric energy is directed from an energy storage location of energy storage locations selected from one of an engine of the aircraft, an auxiliary power unit, or a battery to an electric motor to generate kinetic energy. Wheels of the aircraft are driven using the kinetic energy generated by the electric motor. Movement of the aircraft is decelerated using electric energy from one of the energy storage locations directed to electric motor brakes of the taxiing system.

Another illustrative embodiment of the present disclosure provides a method of taxiing an aircraft. Energy from landing an aircraft is harvested by a number of electric motors connected to landing gear of the aircraft. The energy harvested from landing the aircraft is sent to an engine core of the aircraft and converted to kinetic energy. The aircraft is taxied by sending electric energy generated by extracting the kinetic energy from the engine core to the number of electric motors. motors

Yet another illustrative embodiment of the present disclosure provides a method of powering auxiliary systems of an aircraft. Energy from landing an aircraft is harvested by a number of electric motors connected to landing gear of the aircraft. The energy harvested from landing the aircraft is sent to an auxiliary power unit of the aircraft. Auxiliary operations are powered by the auxiliary power unit using the energy.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an aircraft in which a taxiing system is present in accordance with an illustrative embodiment;

FIG. 2 is an illustration of a plurality of aircraft waiting to taxi to or from a runway in accordance with an illustrative embodiment;

FIG. 3 is an illustration of a diagram of an aircraft having a taxiing system in accordance with an illustrative embodiment;

FIG. 4 is an illustration of an operational diagram of power flow in a taxiing system in accordance with an illustrative embodiment;

FIG. 5 is an illustration of a flowchart of a method of taxiing an aircraft in accordance with an illustrative embodiment;

FIG. 6 is an illustration of a flowchart of a method of taxiing an aircraft in accordance with an illustrative embodiment;

FIG. 7 is an illustration of a flowchart of a method of powering auxiliary systems of an aircraft in accordance with an illustrative embodiment;

FIG. 8 is an illustration of an aircraft manufacturing and service method in a form of a block diagram in accordance with an illustrative embodiment; and

FIG. 9 is an illustration of an aircraft in a form of a block diagram in which an illustrative embodiment may be implemented.

### DETAILED DESCRIPTION

The illustrative embodiments recognize and take into account one or more different considerations. For example, the illustrative embodiments recognize and take into account that when a jet powered aircraft is taxiing under its own power, the method of jet propulsion is inefficient in terms of fuel consumption.

The illustrative embodiments recognize and take into account that as engines idle on an aircraft, fuel is expended. The illustrative embodiments recognize and take into account that it is desirable to reduce fuel waste for environmental and cost reasons. By reducing fuel waste, operating an aircraft is less expensive. By reducing fuel waste, fewer emissions are released for each flight. By reducing fuel waste, non-renewable resources are conserved.

Additionally, increase in aircraft engine ground idle speed involves frequent use of wheel brakes. Frequent use of wheel brakes increases the frequency of brake use during taxi operations. Increasing the frequency of brake use is undesirable for brake thermal management.

The illustrative embodiments recognize and take into account that fuel burn during taxiing can be a significant amount of fuel expenditures for an aircraft. By reducing fuel burn during taxiing, the fuel used by an aircraft is advantageously reduced.

The illustrative embodiments recognize and take into account that operating an aircraft engine produces engine noise and emissions. The illustrative embodiments recognize and take into account that it may be desirable to reduce the cumulative engine noise at an airport. The illustrative embodiments recognize and take into account that it may be desirable to reduce the cumulative emissions at an airport.

Additionally, taxiing frequently requires stopping the aircraft and then re-starting the motion. Taxi stops are accomplished currently using the aircraft brakes. Each taxi stop leads to additional heat in the brake, and each stop creates additional wear. A substantial fraction of total brake wear occurs during taxi, because the initial contact of the brake elements creates a contact wear event which removes some of the brake surface material. The illustrative embodiments recognize and take into account that for aircraft brakes, an amount of brake wear is not correlated to the energy dissipated by the braking. The illustrative embodiments recognize and take into account that braking during taxiing can add considerable wear to aircraft brakes. The illustrative embodiments recognize and take into account that in some cases, braking during taxiing may be substantially the same amount of wear as multiple landings.

The illustrative embodiments recognize and take into account that braking during taxiing generates heating due to stopping. The additional heat absorbed by the brakes during taxiing can sometimes cause a reduction in the available brake energy capability below the allowed limit allowed for takeoff. Takeoff is not allowed unless there is sufficient brake energy capacity to perform an aborted takeoff. Each stop is followed by an additional accelerate to taxi speed event, which consumes additional fuel and creates additional pollutants.

Additionally, the illustrative examples recognize and take into account that there is a limit on the brake temperature prior to takeoff. The illustrative examples recognize and take into account that the limit on brake temperature is to prevent taking off with an undesirably high temperature of brakes. The illustrative examples recognize and take into account that the brakes must have enough “reserve energy” capacity in the brakes to perform a rejected takeoff (emergency stop). The illustrative examples also recognize and take into account that withdrawing hot brakes into the wheel well could potentially damage components of the aircraft. The illustrative examples recognize and take into account that keeping the landing gear extended into the airstream to allow the brakes to cool would lead to a limitation on the airplane's ability to climb.

The illustrative examples recognize and take into account that an aircraft carries extra weight to keep the brakes cool so that the brakes are maintained at a desirable temperature. The illustrative examples recognize and take into account that it would be desirable to reduce the weight of an aircraft to improve fuel efficiency of the aircraft.

The illustrative embodiments recognize and take into account that it is desirable to reduce fuel consumption between flights. The illustrative embodiments recognize and take into account that it may be desirable to power down the engines as soon as possible after a flight to conserve fuel.

The illustrative embodiments recognize and take into account that some ground vehicles include regenerative braking. In regenerative braking, kinetic energy of the ground vehicle is converted into a form that can be stored, such as electric energy. Regenerative braking is most advantageous for ground vehicles that will frequently have in-city driving due to the frequency of stopping in-city.

The illustrative embodiments recognize and take into account that aircraft have different considerations than ground vehicles. Aircraft not only have significantly higher speeds, higher energy consumption, and higher mass, but are also subject to Federal Aviation Regulations. Further, aircraft do not spend a substantial amount of time stopping and starting motion on the ground. Additionally, aircraft system designs take into account weight of the aircraft. An increase in the weight of an aircraft reduces fuel efficiency and decreases the amount of passengers and cargo that can be transported by the aircraft. Accordingly, the illustrative embodiments recognize and take into account that weight considerations also are different between ground vehicles and aircraft.

The illustrative examples present a taxiing system for an aircraft. The taxiing system comprises energy storage locations electrically connected to a number of electric motors, the energy storage locations including at least two of a number of engines of the aircraft, a battery, and an auxiliary power unit of the aircraft; and the number of electric motors connected to wheels of the aircraft to at least one decelerate the wheels by transferring the kinetic energy of the aircraft into electric energy or drive the wheels using electric energy provided by at least one energy storage location of the energy storage locations. Using a number of electric motors in the taxiing system to drive or decelerate the wheels of the aircraft reduces at least one of fuel emissions, fuel waste, braking wear, or engine noise.

As used herein, a first component “connected to” a second component means that the first component can be connected directly or indirectly to the second component. In other words, additional components may be present between the first component and the second component. The first component is considered to be indirectly connected to the second component when one or more additional components are present between the two components. When the first component is directly connected to the second component, no additional components are present between the two components.

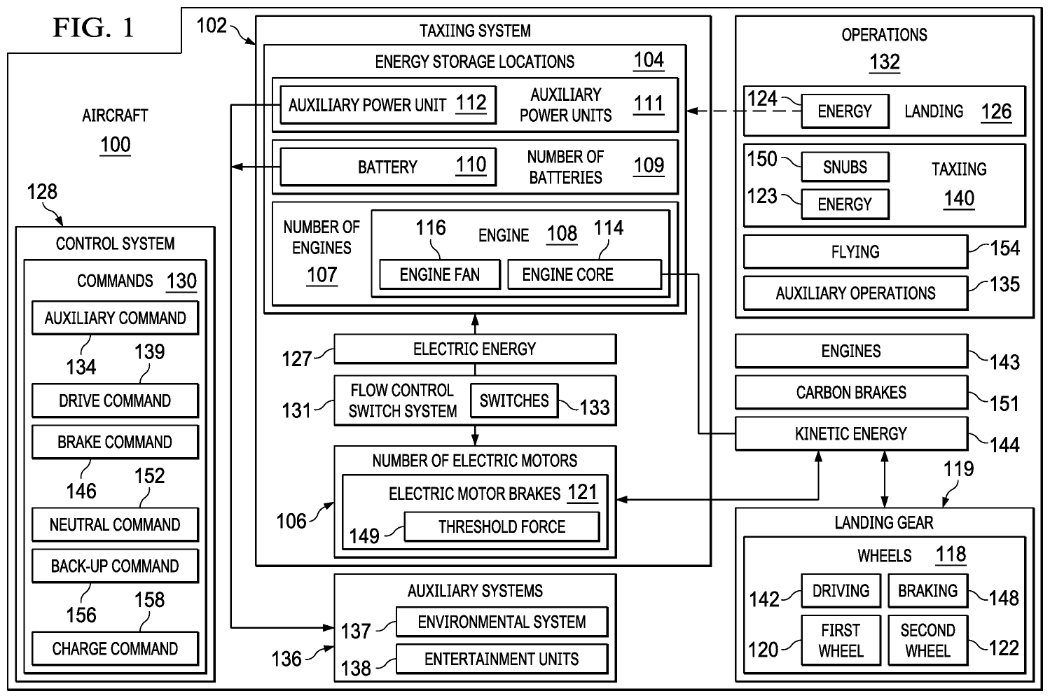

Turning now to FIG. 1, an illustration of a block diagram of an aircraft in which a taxiing system is present is depicted in accordance with an illustrative embodiment. Aircraft 100 has taxiing system 102. Taxiing system 102 comprises energy storage locations 104 and number of electric motors 106. As used herein, a “number of” items is one or more items. For example, number of electric motors 106, is one or more electric motors.

Energy storage locations 104 are electrically connected to number of electric motors 106. Energy storage locations 104 include at least two of number of engines 107, number of batteries 109, and number of auxiliary power units 111 of aircraft 100. As depicted, number of engines 107 includes engine 108, number of batteries 109 includes battery 110, and number of auxiliary power units 111 includes auxiliary power unit 112. Energy storage locations 104 include engine 108 of aircraft 100, battery 110, and auxiliary power unit 112 of aircraft 100. Engine 108 includes rotating elements of engine core 114, including the high-pressure compressor, high pressure shaft, and high-pressure turbine. Engine 108 also includes engine fan 116 comprising the fan which mechanically couples to the low-pressure compressor, shaft, and low-pressure turbine. Components of engine fan 116 are a second separate set of rotating elements from the rotating elements of engine core 114. Engine core 114 refers to the high-pressure rotating elements of engine 108. Engine fan 116 refers to the low-pressure rotating elements of engine 108.

Although energy storage locations 104 as depicted includes one of each of engine, battery, and auxiliary power unit, energy storage locations 104 is not limited to engine 108 of aircraft 100, battery 110, and auxiliary power unit 112. Energy storage locations 104 includes any desirable quantity of at least two of engine, battery, and auxiliary power unit. In other non-depicted examples, energy storage locations 104 includes at least one of more than one engine, more than one battery, or more than one auxiliary power unit.

Engine 108 conventionally only operates in a single direction of rotation. In taxiing system 102, engine 108 generator/motors operate in two quadrants of control. The two quadrants include a motoring mode in which electric energy 127 contributes to adding rotational energy to engine 108 and a generating mode in which the rotating energy is used to produce electric energy 127. Number of engines 107 of aircraft 100 is configured to receive electric energy 127 from the number of electric motors 106 and rotate components of the number of engines 107 using the electric energy 127 in motoring mode. The generating mode is a conventional mode of operation of an engine mounted generator.

Engine 108 motor/generators can be of any type. In some illustrative examples, engine 108 is a wound field three phase generator with an auxiliary permanent magnet exciter which powers the field winding, and is electronically controlled.

Battery 110 is a battery which can be electrically charged or discharged. The state of charge of battery 110 can be measured. Although a battery charge controller is not shown, a battery charge controller can be part of battery 110.

Number of electric motors 106 is connected to wheels 118 of the aircraft to at least one of drive or decelerate wheels 118 using power provided by at least one energy storage location of energy storage locations 104. Decelerating wheels 118 includes all decrease of deceleration. In some illustrative examples, decelerating wheels 118 slows aircraft 100. In some illustrative examples, decelerating wheels 118 stops aircraft 100. In some illustrative examples, decelerating wheels 118 additionally includes keeping aircraft 100 stationary.

Number of electric motors 106 is connected to wheels 118 of landing gear 119 of aircraft 100. Number of electric motors 106 is configured to at least one of: harvest energy 124 from landing 126, harvest energy 124 from decelerating wheels 118 during taxiing 140, drive wheels 118, or decelerate wheels 118. In some illustrative examples, number of electric motors 106 is configured to drive wheels 118 using electric energy in taxiing system 102. In some illustrative examples, number of electric motors 106 act as electric motor brakes 121 to decelerate wheels 118 of aircraft 100.

In some illustrative examples, number of electric motors 106 operates in all four quadrants of operation. Two quadrants of applying a positive torque in either the forward direction or reverse direction, used when propelling aircraft 100 forwards. Two opposite quadrants, when retarding aircraft 100, which is accomplished by absorbing electric energy 127 produced by the stopping action of number of electric motors 106, in the form of increased motor bus voltage.

Number of electric motors 106 take any desirable form. In some illustrative examples, each of number of electric motors 106 is a permanent magnet three phase brushless DC motor in which the motor phases are electronically commutated using control electronics.

Number of electric motors 106 includes one or more motors connected to one or more of wheels 118. In some illustrative examples, number of electric motors 106 includes a first motor connected to first wheel 120 and a second motor connected to second wheel 122. In other illustrative examples, a single electric motor is connected to both first wheel 120 and second wheel 122.

In some illustrative examples, number of electric motors 106 harvest energy 124 from landing 126. In these illustrative examples, number of electric motors 106 is electrically connected to energy storage locations 104 such that energy 124 from landing 126 aircraft 100 is stored in energy storage locations 104. When aircraft 100 is landing 126, number of electric motors 106 is set to direct electric energy 127 generated from energy 124 into energy storage locations 104. In other illustrative examples, number of electric motors 106 are disengaged during landing 126 and do not harvest energy 124 from landing 126. In some illustrative examples, electro-mechanically actuated clutches can be used to engage and disengage number of electric motors 106.

In some illustrative examples, number of electric motors 106 harvest energy 123 from taxiing 140. In some of these illustrative examples, excess electric energy 127 generated by decelerating movement of aircraft 100 during taxiing 140 using number of electric motors 106 is directed to at least one of energy storage locations 104. Energy 123 harvested during taxiing 140 can be directed into non-running engine core 114 or engine fan 116 in a single-engine taxi approach, into running engine 108, or into battery 110.

During landing 126, thrust reversers in an engine, such as engine 108, are employed. In a propeller driven aircraft, reversing propellers is employed during landing 126. Electric energy 127 generated by number of electric motors 106 in a regenerative mode can be supplied to engine 108 to create the reverse thrust to slow aircraft 100. Providing electric energy 127 to generate reverse thrust by engine 108 during landing 126 reduces fuel consumption.

Energy storage locations 104 take any desirable form. In some illustrative examples, energy storage locations 104 include auxiliary power unit 112. When energy storage locations 104 includes auxiliary power unit 112, number of electric motors 106 is electrically connected to auxiliary power unit 112. In some illustrative examples, number of electric motors 106 is electrically connected to auxiliary power unit 112 bidirectionally. When number of electric motors 106 is bidirectionally electrically connected to auxiliary power unit 112, number of electric motors 106 can both send electric energy 127 to and receive electric energy 127 from auxiliary power unit 112. In some illustrative examples, auxiliary power unit 112 spins to absorb electric energy 127. In some illustrative examples, a motor (not depicted) of auxiliary power unit 112 spins to absorb electric energy 127. Auxiliary power unit 112 uses the electric energy 127 received from number of electric motors 106 to perform operations for which auxiliary power unit 112 conventionally provides power. In some illustrative examples, auxiliary power unit 112 uses the electric energy 127 received from number of electric motors 106 to perform auxiliary operations 135. In some illustrative examples, number of auxiliary power units 111 is configured to receive electric energy 127 from number of electric motors 106 and rotate components of number of auxiliary power units 111 using the electric energy 127. In some illustrative examples, electric energy 127 is sent to auxiliary power units 111 to power auxiliary systems 136 to perform auxiliary operations 135. As depicted, auxiliary systems 136 include environmental system 137 and entertainment units 138. Environmental system 137 provides heating and cooling to a passenger cabin of aircraft 100. Entertainment units 138 include screens, audio, or other types of entertainment systems provided to passengers within aircraft 100. The depiction of auxiliary systems 136 is not limiting, auxiliary systems 136 include any desirable types of systems.

Auxiliary power unit 112 generator/motor acts only in a single direction of rotation, but operates in both quadrants. Auxiliary power unit 112 acts as a generator in conventional operation to convert mechanical rotary power into electrical power or as a motor, in which electric energy 127 is converted to rotating power.

In some illustrative examples, energy storage locations 104 includes battery 110. When energy storage locations 104 includes battery 110, number of electric motors 106 is electrically connected to battery 110. In some illustrative examples, number of electric motors 106 is electrically connected to battery 110 bidirectionally. When number of electric motors 106 is bidirectionally electrically connected to battery 110, number of electric motors 106 can both send electric energy 127 to and receive electric energy 127 from battery 110. Battery 110 stores electric energy 127 generated by number of electric motors 106. Battery 110 stores electric energy 127 for powering number of electric motors 106 in taxiing 140.

In some illustrative examples, energy storage locations 104 includes engine 108. When energy storage locations 104 includes engine 108, number of electric motors 106 is electrically connected to engine 108. In some illustrative examples, number of electric motors 106 is electrically connected to engine 108 bidirectionally. When number of electric motors 106 is bidirectionally electrically connected to engine 108, number of electric motors 106 can both send electric energy 127 to and receive electric energy 127 from engine 108. In some illustrative examples, engine 108 spins to absorb electric energy 127. In some illustrative examples, a motor (not depicted) of engine 108 spins to absorb electric energy 127. The motor may be a part of either engine core 114 or engine fan 116. Engine 108 uses the electric energy 127 received from number of electric motors 106 to operate with reduced fuel. In some illustrative examples, engine 108 uses the electric energy 127 received from number of electric motors 106 to keep engine 108 powered with reduced fuel usage.

In some illustrative examples, it is desirable to speed up at least one of engine core 114 or engine fan 116 during landing 126 to provide reverse thrust. In these illustrative examples, electric energy 127 can be supplied to engine 108 during thrust reverser deployment. Reverse thrust helps with providing deceleration during landing 126. In other illustrative examples, it would be desirable to direct electric energy 127 to propellers of a propeller aircraft with the propellers reversed.

Aircraft 100 has control system 128 configured to send commands 130 to flow control switch system 131 to direct electric energy 127 between energy storage locations 104 and number of electric motors 106. In some illustrative examples, flow control switch system 131 is referred to as a power/energy flow control switch system. Control system 128 may also be referred to as a controller.

Control system 128 is configured to direct electric energy 127 generated by number of electric motors 106 to at least one battery of number of batteries 109. Control system 128 is configured to direct electric energy 127 generated by number of electric motors 106 to at least one of an engine of number of engines 107 of aircraft 100 or an auxiliary power unit of number of auxiliary power units 111 when battery 110 reaches a charge capacity.

Flow control switch system 131 may also be referred to as a “power switch matrix”. Flow control switch system 131 can be referred to as a combination of switches 133 which connect electrical power generating sources to loads. While a system can be implemented used electrical switches 133, in another embodiment, these switches 133 can be implemented within the electrical motor/generator controls themselves, such that the switching function is implemented in a logical fashion without requiring actual physical switches.

Engine 108 and auxiliary power unit 112 each have motor devices. At the controller for each of these motor devices, operation in regenerative mode will tend to raise the electrical voltage of the connected electrical bus, which can be detrimental to the connected loads. Consequently, the electrical power control system 128 signals to one or more of another rotating element motor/generator controllers a request to increase the speed of that element, e.g. to convert from generating mode to motoring mode. At the same time, any fuel supplied to the rotating element's engine core 114 is reduced, to prevent the element speed from rising to an excessive level. Rotation can also be added to rotating elements of engine 108 which have no fuel consumption and are simply rotating masses used as an energy storage system.

In the case where the regenerative energy is sent to battery 110, it simply acts as a charging current, but a protection means is provided to limit the charging current to a safe level. If the energy exceeds the capacity of battery 110 to absorb it, control system 128 activates additional power sinks by changing the control of rotating elements from generating mode to motoring mode.

When the retarding force available from operating number of electric motors 106 in regenerative (generating mode) is insufficient to slow aircraft 100, conventional aircraft friction brakes, such as carbon brakes 151, may be used to provide additional retarding force.

Motor/generator outputs are typically three phase, but number of electric motors 106 operate over a wide speed range, their control electronics converts the AC input to a DC bus voltage. Therefore, when an AC system is used, a feature of the motor controllers will have to include the ability to phase synchronize to the applied power such that current will flow out of the device in phase with the bus voltage.

Control system 128 sends commands 130 to flow control switch system 131 depending upon a desired operation of operations 132. Commands 130 are sent to set switches 133 to perform at least one operation of operations 132. Switches 133 direct the movement of electric energy 127 within taxiing system 102. Switches 133 direct the movement of electric energy 127 between number of electric motors 106 and energy storage locations 104. As depicted, commands 130 include auxiliary command 134, drive command 139, brake command 146, neutral command 152, and back-up command 156, and charge command 158.

Although not depicted in FIG. 1, a pilot can be present in aircraft 100. When aircraft 100 is piloted, brake command 146 is generated when the pilot applies their feet to brake pedals of aircraft 100, which are conventionally mounted on top of the rudder pedals. Application of pressure to the brake pedals indicates a request to retard or halt the motion of aircraft 100, and the control system 128 does so. In some illustrative examples, drive command 139 to move aircraft 100 forward is generated when a pilot provides physical pressure or movement of a new pilot control, such as a taxi control, to provide an input. In other illustrative examples, in an unmanned or unpiloted aircraft, drive command 139 is generated based on alternative input.

In some illustrative examples, brake command 146 is generated based on input from an autobrake system. An autobrake system automatically applies and controls braking during landings. In some illustrative examples, when aircraft 100 is an unmanned or unpiloted aircraft, commands 130 are generated as part of a centralized aircraft control system and are not generated based on physical input by a pilot present on aircraft 100.

In some illustrative examples, taxiing system 102 is operated during landing 126 to store energy 124 from landing 126 in at least one of energy storage locations 104. In some illustrative examples, during landing 126, energy 124 of landing 126 is converted to electric energy 127 by number of electric motors 106. Number of electric motors 106 is connected to energy storage locations 104 such that energy 124 from landing 126 aircraft 100 is stored in energy storage locations 104. In some illustrative examples, to store energy 124, control system 128 sends charge command 158.

Number of electric motors 106 harvests a fraction of the total energy in landing 126. Number of electric motors 106 harvests a fraction of the total energy in landing 126 based on threshold force 149 of electric motor brakes 121.

Control system 128 sends drive command 139 to taxiing system 102 to perform taxiing 140. Drive command 139 includes instructions to set switches 133 to direct electric energy 127 to number of electric motors 106. Drive command 139 instructs number of electric motors 106 connected to wheels 118. Driving 144 of wheels 118 of aircraft 100 during taxiing 140 is performed using kinetic energy 145 generated by number of electric motors 106 from electric energy 127 from at least one of energy storage locations 104.

Control system 128 sends brake command 146 to number of electric motors 106 to perform braking 148 of wheels 118 during taxiing 140. During braking 148, aircraft 100 is decelerated using electric energy 127 provided by energy storage locations 104 in taxiing system 102. In some illustrative examples, braking 148 is performed by energy stored from landing 126 aircraft 100. Snubs 150 of carbon brakes 153 during taxiing 140 are reduced or eliminated when taxiing system 102 performs braking 148 of wheels 118. In some illustrative examples, when electric motor brakes 121 decelerate aircraft 100, aircraft 100 may be decelerated without engaging carbon brakes 153. Although taxiing system 102 performs braking 148 of wheels 118, carbon brakes 153 are still available if braking 148 using carbon brakes 153 is desired. In some illustrative examples, electric motor brakes 121 and carbon brakes 153 are engaged to decelerate aircraft 100.

In some illustrative examples, control system 128 sends neutral command 152 when taxiing system 102 is not actively driving 142 or braking 148 wheels 118. In some illustrative examples, neutral command 152 sets taxiing system 102 such that number of electric motors 106 do not apply force to wheels 118. In some illustrative examples, control system 128 sends neutral command 152 prior to aircraft 100 flying 154. In some illustrative examples, neutral command 152 and charge command 158 are the same.

Neutral command 152, places taxiing system 102 into a neutral condition. Neutral command 152 disengages number of electric motors 106 from wheels 118. A traction motor providing high performance at low speed may be adversely affected by high speed operation. By neutral command 152 mechanically disengaging number of electric motors 106 from wheels 118, number of electric motors 106 are not engaged during high speed operation.

In some illustrative examples, taxiing system 102 is used for backing aircraft 100 from a gate. In some illustrative examples, control system 128 sends drive command 139 regardless of the direction of movement of aircraft 100. In these illustrative examples, control system 128 sends drive command 139 for backing up aircraft 100 from a gate. In these illustrative examples, flow of power within taxiing system 102 to number of electric motors 106 is the same for taxiing 140 and backing-up of aircraft 100. In these illustrative examples, additional non-depicted mechanical components may reverse rotational direction of wheels 118. In other illustrative examples, control system 128 sends back-up command 156 to back up aircraft 100 using taxiing system 102.

In some illustrative examples, taxiing system 102 performs taxiing 140 without energy from engines 143. By using taxiing system 102 to perform taxiing 140, fuel used by engines 143 during taxiing 140 is reduced. In some illustrative examples, taxiing system 102 allows aircraft 100 to perform taxiing 140 without engaging engines 143. In these illustrative examples, taxiing system 102 uses electric energy 127 from one of battery 110 or auxiliary power unit 112.

In some illustrative examples, taxiing system 102 performs taxiing 140 using engines 143 and energy 124 from landing 126 sent to engine core 114. Engine 108 is one of engines 143. By sending energy 124 from landing 126 to engine core 114, fuel used by engines 143 during taxiing 140 is reduced.

The illustration of aircraft 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

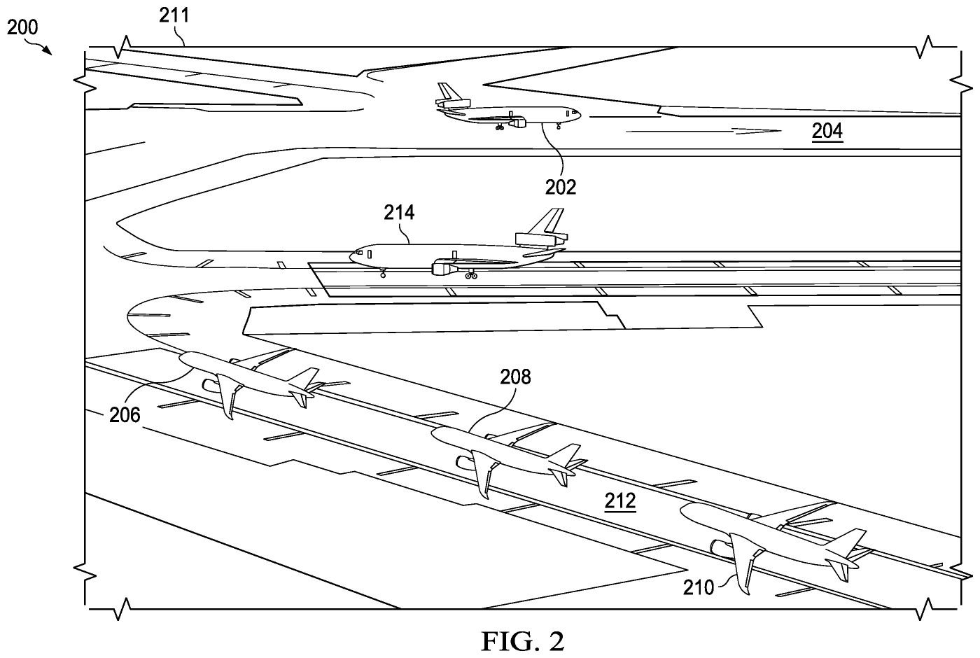

For example, although not depicted in FIG. 2, motors connected to each of auxiliary power unit 112, engine core 114, engine fan 116 may be present. For example, separate motors may be present for each of engine core 114 and engine fan 116 to absorb amounts of energy 124 from landing 126.

Turning now to FIG. 2, an illustration of a plurality of aircraft waiting to taxi to or from a runway is depicted in accordance with an illustrative embodiment. In view 200, aircraft 202 is present on runway 204. Aircraft 202 is preparing to takeoff on runway 204. Aircraft 202 has its engines running in preparation for takeoff.

Each of aircraft 206, aircraft 208, and aircraft 210 are present on taxiway 212. Each of aircraft 206, aircraft 208, and aircraft 210 are waiting to taxi to another location in airport 211. If any of aircraft 206, aircraft 208, or aircraft 210 are conventional aircraft, the respective conventional aircraft will idle with the respective conventional aircraft's engines running.

Any of aircraft 202, aircraft 206, aircraft 208, or aircraft 210 may be aircraft 100 of FIG. 1. Any of aircraft 202, aircraft 206, aircraft 208, or aircraft 210 may have taxiing system 102 of FIG. 1.

When aircraft 206 has a taxiing system with electric motors connected to the wheels of the landing gear, aircraft 206 is configured to taxi without operating the engines of aircraft 206. When aircraft 208 has a taxiing system with electric motors connected to the wheels of the landing gear, aircraft 208 is configured to taxi without operating the engines of aircraft 208. When aircraft 210 has a taxiing system with electric motors connected to the wheels of the landing gear, aircraft 210 is configured to taxi without operating the engines of aircraft 210. When the engines of an aircraft are not operated, fuel consumption of the respective aircraft is reduced. For each of aircraft 206, aircraft 208, and aircraft 210 that has a taxiing system with electric motors connected to the wheels of the landing gear, electric energy from an energy storage location other than the engines of the respective aircraft powers the taxiing of the aircraft.

In some illustrative examples, one of a battery or an auxiliary power unit powers electric motors connected to the landing gear of aircraft 206 to drive aircraft 206 during taxiing. In some illustrative examples, one of a battery or an auxiliary power unit powers electric motors connected to the landing gear of aircraft 208 to drive aircraft 208 during taxiing. In some illustrative examples, one of a battery or an auxiliary power unit powers electric motors connected to the landing gear of aircraft 210 to drive aircraft 210 during taxiing.

For each aircraft of aircraft 206, aircraft 208, and aircraft 210 that has a taxiing system electric motors connected to the wheels of the landing gear, idling emissions in airport 211 are reduced. Idling emissions in airport 211 can be reduced by at least one of taxiing using electric motors or operating the aircraft engines using electric energy generated from harvesting kinetic energy from decelerating the respective aircraft. For each aircraft of aircraft 206, aircraft 208, and aircraft 210 that has a taxiing system with electric motors connected to the wheels of the landing gear, engine noise in airport 211 is reduced.

When aircraft 206 has a taxiing system with electric motors connected to the wheels of the landing gear, the taxiing system decelerates movement of aircraft 206 using the electric motors in the taxiing system. In some illustrative examples, when aircraft 206 has a taxiing system with electric motors connected to the wheels of the landing gear, aircraft 206 is configured to taxi without engaging the carbon brakes of aircraft 206. When aircraft 206 is configured to taxi without engaging the carbon brakes of aircraft 206, the carbon brakes of aircraft 206 may be replaced less frequently, thus reducing maintenance costs of aircraft 206. Although aircraft 206 is configured to decelerate without engaging the carbon brakes of aircraft 206, carbon brakes are still available and prepared for braking if desired.

When aircraft 208 has a taxiing system with electric motors connected to the wheels of the landing gear, the taxiing system decelerates movement of aircraft 208 using the electric motors in the taxiing system. In some illustrative examples, when aircraft 208 has a taxiing system with electric motors connected to the wheels of the landing gear, aircraft 208 is configured to taxi without engaging the carbon brakes of aircraft 208. When aircraft 208 is configured to taxi without engaging the carbon brakes of aircraft 208, the carbon brakes of aircraft 208 may be replaced less frequently, thus reducing maintenance costs of aircraft 208. Although aircraft 208 is configured to decelerate without engaging the carbon brakes of aircraft 208, carbon brakes are still available and prepared for braking if desired.

When aircraft 210 has a taxiing system with electric motors connected to the wheels of the landing gear, the taxiing system decelerates movement of aircraft 210 using the electric motors in the taxiing system. In some illustrative examples, when aircraft 210 has a taxiing system with electric motors connected to the wheels of the landing gear, aircraft 210 is configured to taxi without engaging the carbon brakes of aircraft 210. When aircraft 210 is configured to taxi without engaging the carbon brakes of aircraft 210, the carbon brakes of aircraft 210 may be replaced less frequently, thus reducing maintenance costs of aircraft 210. Although aircraft 210 is configured to decelerate without engaging the carbon brakes of aircraft 210, carbon brakes are still available and prepared for braking if desired.

Aircraft 214 is also present in view 200. Aircraft 214 is a larger aircraft than any of aircraft 206, aircraft 208, or aircraft 210. In some illustrative examples, aircraft 214 may be aircraft 100 of FIG. 1. In some illustrative examples, aircraft 214 has taxiing system 102 of FIG. 1. When aircraft 214 has a taxiing system with electric motors connected to the wheels of the landing gear, aircraft 214 is configured to taxi without operating the engines of aircraft 214. When the engines of aircraft 214 are not operated, fuel consumption of aircraft 214 is reduced. When aircraft 214 has a taxiing system with electric motors connected to the wheels of the landing gear, idling emissions in airport 211 are further reduced. When aircraft 214 has a taxiing system with electric motors connected to the wheels of the landing gear, engine noise in airport 211 is further reduced.

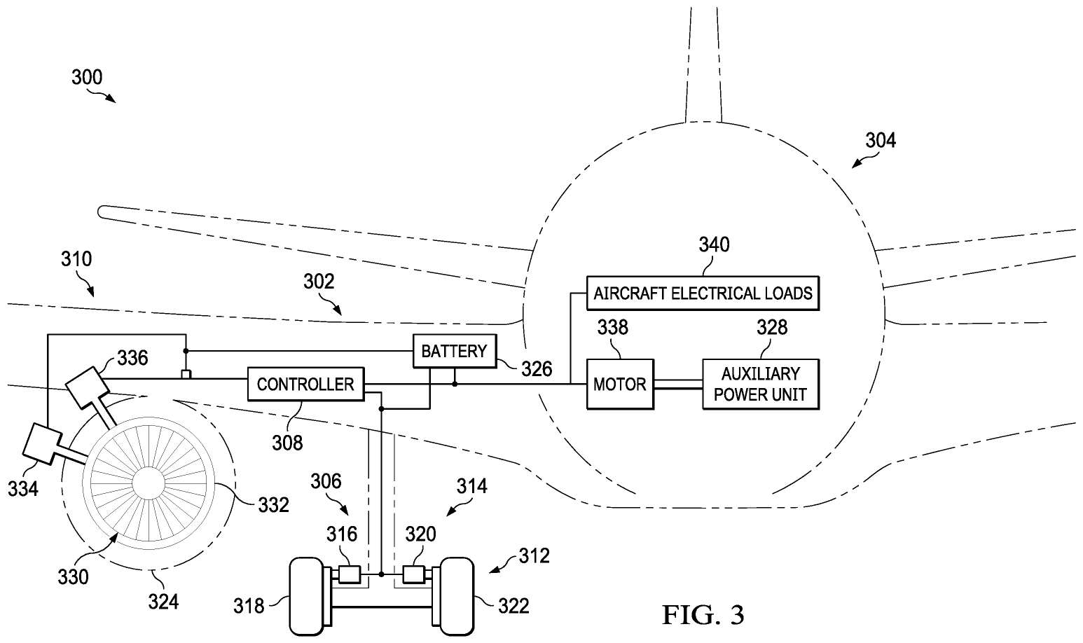

Turning now to FIG. 3, an illustration of a diagram of an aircraft having a taxiing system is depicted in accordance with an illustrative embodiment. View 300 depicts locations of components of taxiing system 302 in aircraft 304. Taxiing system 302 is a schematic representation of taxiing system 102 of FIG. 1. Taxiing system 302 may be implemented in any of aircraft 202, aircraft 206, aircraft 208, aircraft 210, or aircraft 214.

Taxiing system 302 comprises number of electric motors 306, controller 308, and energy storage locations 310. Number of electric motors 306 is connected to wheels 312 of landing gear 314. As depicted, number of electric motors 306 includes electric motor 316 connected to wheel 318 and electric motor 320 connected to wheel 322.

Number of electric motors 306 are configured to drive or decelerate wheels 312 using electric energy provided by one of energy storage locations 310. In some illustrative examples, electric energy is provided to number of electric motors 306 by one of energy storage locations 310 to drive wheels 312. In some illustrative examples, electric energy is provided to number of electric motors 306 by one of energy storage locations 310 to decelerate wheels 312. In these illustrative examples, number of electric motors 306 act as electric motor brakes.

Decelerating wheels 312 slows aircraft 304. In some illustrative examples, decelerating wheels 312 stops aircraft 304. In some illustrative examples, decelerating wheels 312 additionally includes keeping aircraft 304 stationary.

Energy storage locations 310 includes at least two of a number of engines, a number of batteries, and a number of auxiliary power units of aircraft 304. Energy storage locations 310 include engine 324, battery 326, and auxiliary power unit 328. Engine 324 includes engine core 330 and engine fan 332. Engine core 330 has motor 334. Motor 334 may also be referred to as a generator or a motor/generator. Engine fan 332 has motor 336. Motor 336 may also be referred to as a generator or a motor/generator. In some illustrative examples, at least one component of engine 324 provides energy to operate at least one motor of number of electric motors 306. In some illustrative examples, at least one component of engine 324 provides energy to number of electric motors 306 to drive at least one wheel of wheels 312. In some illustrative examples, at least one component of engine 324 provides energy to number of electric motors 306 to decelerate at least one wheel of wheels 312.

In some illustrative examples, at least one component of engine 324 absorbs energy generated by number of electric motors 306 as wheels 312 are decelerated. In one illustrative example, energy is sent from number of electric motors 306 to spin engine fan 332. In another illustrative example, energy is sent form number of electric motors 306 to engine core 330.

Auxiliary power unit 328 has motor 338. Motor 338 may be referred to as motor/generator. In some illustrative examples, auxiliary power unit 328 provides energy to operate at least one motor of number of electric motors 306. In some illustrative examples, auxiliary power unit 328 provides energy to number of electric motors 306 to drive at least one wheel of wheels 312. In some illustrative examples, auxiliary power unit 328 provides energy to number of electric motors 306 to decelerate at least one wheel of wheels 312.

Controller 308 may also be referred to as a control system. Controller 308 is an implementation of control system 128 of FIG. 1. Controller 308 is configured to send commands to a flow control switch system to direct electric energy between energy storage locations 310 and number of electric motors 306.

The flow control switch system comprising a plurality of switches configured to direct electric energy between energy storage locations 310 and number of electric motors 306. The plurality of switches is configured to change flow of electric energy within taxiing system 302 to perform at least one of moving aircraft 304 using number of electric motors 306, braking aircraft 304 using taxiing system 302, or storing electric energy in at least one of energy storage locations 310.

Controller 308 is configured to direct electric energy generated by number of electric motors 306 to battery 326. Controller 308 is configured to direct electric energy generated by number of electric motors 306 to at least one of engine 324 of aircraft 304 or auxiliary power unit 328 when battery 326 reaches a charge capacity.

Although not depicted, controller 308 receives inputs from different sources to control taxiing system 302. In one non-limiting example, controller 308 can generate commands such as drive commands, brake commands, neutral commands, or other commands to taxiing system 302 based on input from a pilot. In other illustrative examples, controller 308 can generate commands based on input provided by an autobrake system or other automated system.

Aircraft electrical loads 340 are also present on aircraft 304. Aircraft electrical loads 340 are conventional electrical loads that are powered by either engine 324 or auxiliary power unit 328. Aircraft electrical loads 340 are still powered when taxiing system 302 is present in aircraft 304. Controller 308 continues to power aircraft electrical loads 340 with stable power.

In some illustrative examples, engine 324 of aircraft 304 is configured to receive electric energy from number of electric motors 306 and rotate components of engine 324 using the electric energy. For example, at least one of motor 334 or motor 336 may be rotated using the electric energy from number of electric motors 306. In some illustrative examples, auxiliary power unit 328 is configured to receive electric energy from number of electric motors 306 and rotate components of auxiliary power unit 328 using the electric energy.

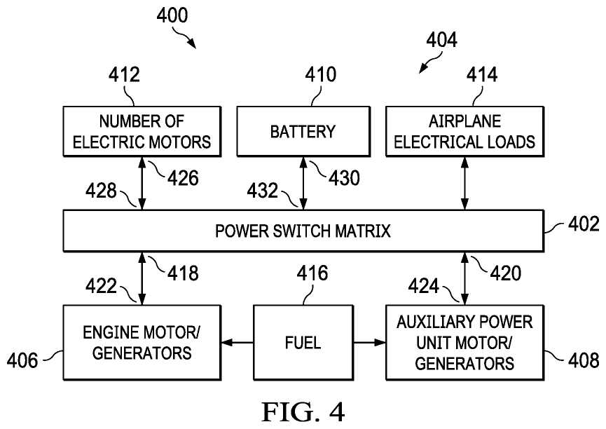

Turning now to FIG. 4, an illustration of an operational diagram of power flow in a taxiing system is depicted in accordance with an illustrative embodiment. Flow diagram 400 is an example of flow of electric energy 127 in taxiing system 102 of FIG. 1. Flow diagram 400 may be an example of flow of electric energy in a taxiing system of any of aircraft 202, aircraft 206, aircraft 208, aircraft 210, or aircraft 214. Flow diagram 400 may be implemented in taxiing system 302 of FIG. 3.

Flow diagram 400 includes power switch matrix 402 configured to direct flow of electric energy within taxiing system 404. Power switch matrix 402 directs electric energy flow to and from each of engine 406 motor/generators, auxiliary power unit 408 motor/generators, battery 410, number of electric motors 412 attached to the wheels of the aircraft, and aircraft electrical loads 414.

As depicted, when engine 406 does not receive electric energy from power switch matrix 402, engine 406 is powered by fuel 416. When powered by fuel 416, engine 406 provides 418 electric energy to power switch matrix 402. As depicted, when auxiliary power unit 408 does not receive electric energy from power switch matrix 402, auxiliary power unit 408 is powered by fuel 416. When powered by fuel 416, auxiliary power unit 408 provides 420 electric energy to power switch matrix 402.

In taxiing system 404, power switch matrix 402 can direct electric energy into either of engine 406 or auxiliary power unit 408. As depicted, power switch matrix 402 can direct electric energy from either number of electric motors 412 or battery 410 into engine 406 or auxiliary power unit 408. When engine 406 receives 422 electric energy, engine 406 operates with less fuel 416. When auxiliary power unit 408 receives 424 electric energy, auxiliary power unit 408 uses less fuel 416.

Number of electric motors 412 attached to wheels of the aircraft can be used to either drive or brake the wheels. When number of electric motors 412 drive the wheels of the aircraft, number of electric motors 412 receive 426 electric energy. Power switch matrix 402 directs electric energy from one of battery 410, engine 406, or auxiliary power unit 408 to power number of electric motors 412.

In some illustrative examples, number of electric motors 412 generate 428 electric energy. In these illustrative examples, number of electric motors 412 harvest kinetic energy of an aircraft while decelerating the aircraft. In these illustrative examples, number of electric motors 412 convert kinetic energy to electric energy.

Power switch matrix 402 distributes electric energy generated 428 by number of electric motors 412 to at least one of battery 410, engine 406, auxiliary power unit 408, or aircraft electrical loads 414. In some illustrative examples, power switch matrix 402 sends 430 electric energy to battery 410. In some illustrative examples, power switch matrix 402 sends 432 electric energy from battery 410 to power number of electric motors 412.

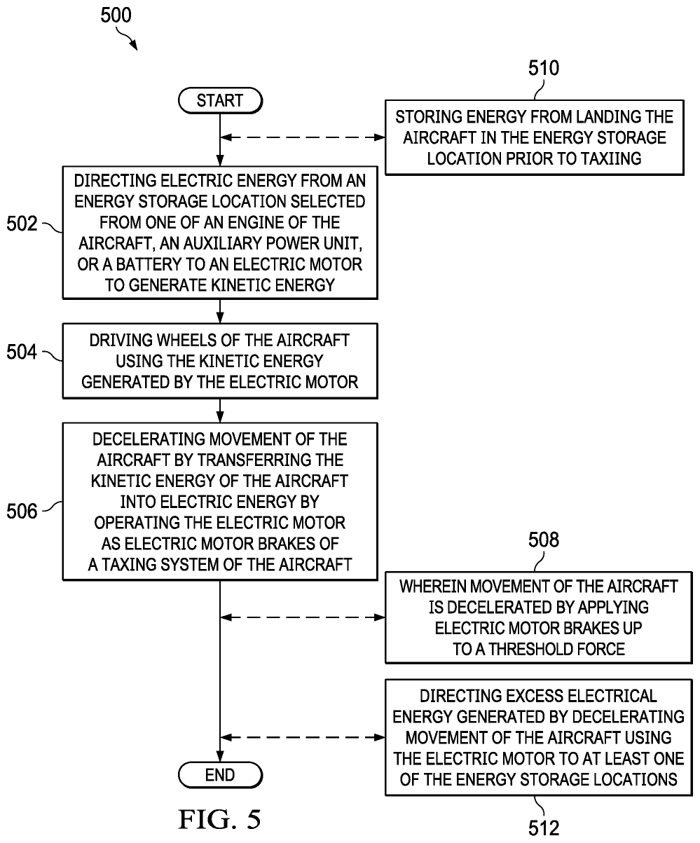

Turning now to FIG. 5, an illustration of a flowchart of a method of taxiing an aircraft is depicted in accordance with an illustrative embodiment. Method 500 may be performed using taxiing system 102 of FIG. 1. Method 500 may be implemented in at least one of aircraft 202, aircraft 206, aircraft 208, aircraft 210, or aircraft 214 of FIG. 2. Method 500 may be performed using taxiing system 302 of FIG. 3. Method 500 may be performed using taxiing system 404 of FIG. 4.

Method 500 directs electric energy from an energy storage location of energy storage locations selected from one of an engine of the aircraft, an auxiliary power unit, or a battery to an electric motor to generate kinetic energy (operation 502). Method 500 drives wheels of the aircraft using the kinetic energy generated by the electric motor (operation 504). Method 500 decelerates movement of the aircraft by transferring the kinetic energy of the aircraft into electric energy by operating the electric motor as electric motor brakes of a taxiing system of the aircraft (operation 506). Decelerating movement of the aircraft slows the aircraft. In some illustrative examples, decelerating movement of the aircraft stops the aircraft. Afterwards, method 500 terminates.

In some illustrative examples, movement of the aircraft is decelerated by applying electric motor brakes up to a threshold force (operation 508). The threshold force is a maximum force that can be applied by the electric motor brakes.

In some illustrative examples, energy from landing the aircraft is stored in the energy storage location prior to taxiing (operation 510). In these illustrative examples, energy stored from landing the aircraft can be only a portion of the kinetic energy from landing the aircraft. In these illustrative examples, regenerative energy from landing the aircraft can be used in taxiing the aircraft.

In some illustrative examples method 500 directs excess electric energy generated by decelerating movement of the aircraft using the electric motor to at least one of the energy storage locations (operation 512). By directing the excess electric energy to at least one of the energy storage locations, energy from braking the aircraft during taxiing is harvested. This regenerative energy reduces fuel consumption of the aircraft.

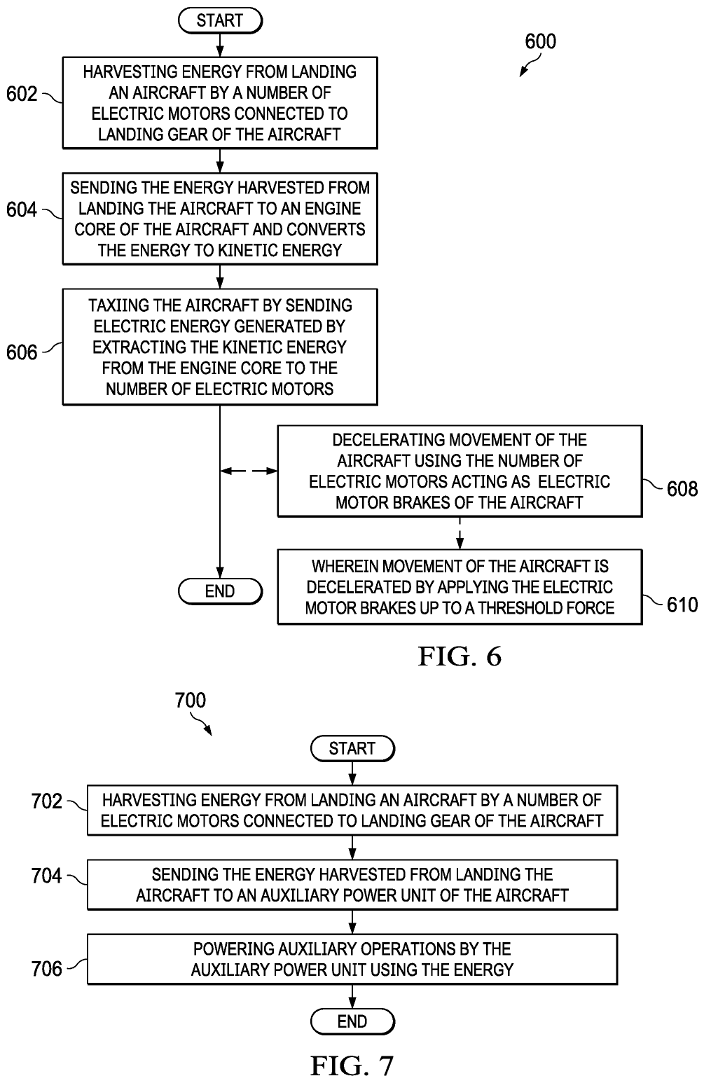

Turning now to FIG. 6, an illustration of a flowchart of a method of taxiing an aircraft is depicted in accordance with an illustrative embodiment. Method 600 may be performed using taxiing system 102 of FIG. 1. Method 600 may be implemented in at least one of aircraft 202, aircraft 206, aircraft 208, aircraft 210, or aircraft 215 of FIG. 2. Method 600 may be performed using taxiing system 302 of FIG. 3. Method 600 may be performed using taxiing system 404 of FIG. 4.

Method 600 harvests energy from landing an aircraft by a number of electric motors connected to landing gear of the aircraft (operation 602). Method 600 sends the energy harvested from landing the aircraft to an engine core of the aircraft and converts the energy to kinetic energy (operation 604). Method 600 taxis the aircraft by sending electric energy generated by extracting the kinetic energy from the engine core to the number of electric motors (operation 606). Afterwards, method 600 terminates.

In some illustrative examples, method 600 decelerates movement of the aircraft using the number of electric motors acting as electric motor brakes of the aircraft (operation 608). In some illustrative examples, decelerating movement slows the aircraft. In some illustrative examples, decelerating movement stops the aircraft. In some illustrative examples, movement of the aircraft is decelerated by applying the electric motor brakes up to a threshold (operation 610).

Turning now to FIG. 7, an illustration of a flowchart of a method of operating an auxiliary system of an aircraft is depicted in accordance with an illustrative embodiment. Method 700 may be performed using taxiing system 102 of FIG. 1. Method 700 may be implemented in at least one of aircraft 202, aircraft 206, aircraft 208, aircraft 210, or aircraft 216 of FIG. 2. Method 700 may be performed using taxiing system 302 of FIG. 3. Method 700 may be performed using taxiing system 404 of FIG. 4.

Method 700 harvests energy from landing an aircraft by a number of electric motors connected to landing gear of the aircraft (operation 702). Method 700 sends the energy harvested from landing the aircraft to an auxiliary power unit of the aircraft (operation 704). Method 700 operates auxiliary operations by the auxiliary power unit using the energy (operation 706). Afterwards, method 700 terminates.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, “at least one of item A, item B, or item C” may include, without limitation, item A, item A and item B, or item B. This example also may include item A, item B, and item C, or item B and item C. Of course, any combination of these items may be present. In other examples, “at least one of” may be, for example, without limitation, two of item A, one of item B, and ten of item C; four of item B and seven of item C; or other suitable combinations.

The flowcharts and block diagrams in the different depicted embodiments illustrate the architecture, functionality, and operation of some possible implementations of apparatus and methods in an illustrative embodiment. In this regard, each block in the flowcharts or block diagrams may represent a module, a segment, a function, and/or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added, in addition to the illustrated blocks, in a flowchart or block diagram. Some blocks may be optional.

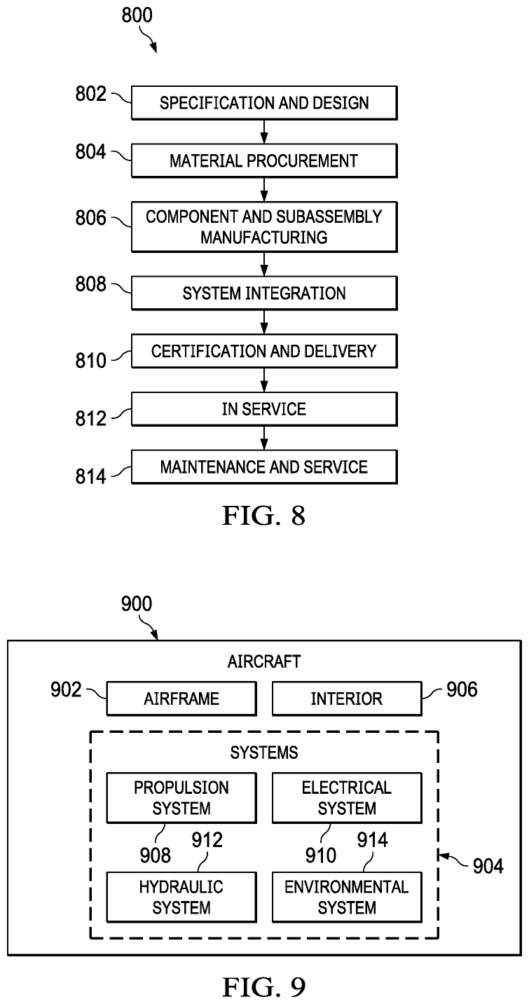

Illustrative embodiments of the present disclosure may be described in the context of aircraft manufacturing and service method 800 as shown in FIG. 8 and aircraft 900 as shown in FIG. 9. Turning first to FIG. 8, an illustration of an aircraft manufacturing and service method is depicted in accordance with an illustrative embodiment. During pre-production, aircraft manufacturing and service method 800 may include specification and design 802 of aircraft 900 in FIG. 9 and material procurement 804.

During production, component and subassembly manufacturing 806 and system integration 808 of aircraft 900 takes place. Thereafter, aircraft 900 may go through certification and delivery 810 in order to be placed in service 812. While in service 812 by a customer, aircraft 900 is scheduled for routine maintenance and service 814, which may include modification, reconfiguration, refurbishment, or other maintenance and service.

Each of the processes of aircraft manufacturing and service method 800 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 9, an illustration of an aircraft is depicted in which an illustrative embodiment may be implemented. In this example, aircraft 900 is produced by aircraft manufacturing and service method 800 of FIG. 8 and may include airframe 902 with plurality of systems 904 and interior 906. Examples of systems 904 include one or more of propulsion system 908, electrical system 910, hydraulic system 912, and environmental system 914. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 800. One or more illustrative embodiments may be manufactured or used during at least one of component and subassembly manufacturing 806, system integration 808, in service 812, or maintenance and service 814 of FIG. 8. For example, taxiing system 102 may be manufactured or installed during component and subassembly manufacturing 806. Taxiing system 102 may be connected to electrical system 910 of aircraft 900 during component and subassembly manufacturing 806. As an example, method 500 may be used during in service 812 to taxi aircraft 900. As another illustrative example, taxiing system 102 may be installed during maintenance and service 814. Taxiing system 102 may reduce frequency of maintenance and service 814 for other components of aircraft 900, such as carbon brakes. In some illustrative examples, method 500 may be used to operate portions of aircraft 900 such as portions of propulsion system 908. In some illustrative examples, method 500 may utilize electric system 910 of aircraft 900. Further, landing gear 119 of FIG. 1 is part of or connected to airframe 902 of aircraft 900.

The illustrative examples provide a taxiing system for an aircraft. The taxiing system uses electric energy to perform at least one of taxiing the aircraft or braking the aircraft. In some illustrative examples, the taxiing system generates electric energy from landing energy of the aircraft.

By employing the taxiing system, the aircraft may taxi without running the aircraft engines. The illustrative examples reduce the fuel consumed during taxiing of the aircraft. The illustrative examples reduce the fuel emissions generated by an aircraft during taxiing. The illustrative examples may reduce the wear on the carbon brakes of an aircraft due to taxiing. In some illustrative examples, the carbon brakes of an aircraft may be used for more flights due to braking using the taxiing system.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A taxiing system for an aircraft, the taxiing system comprising:
energy storage locations electrically connected to a number of electric motors, the energy storage locations including at least two of a number of engines of the aircraft, a number of batteries, and a number of auxiliary power units of the aircraft; and
the number of electric motors connected to wheels of the aircraft to at least one of decelerate the wheels by transferring kinetic energy of the aircraft into electric energy or drive the wheels using electric energy provided by at least one energy storage location of the energy storage locations.

2. The taxiing system of claim 1 further comprising:
a control system configured to send commands to a flow control switch system to direct electric energy between the energy storage locations and the number of electric motors.

3. The taxiing system of claim 2 further comprising:
the flow control switch system comprising a plurality of switches configured to direct electric energy between the energy storage locations and the number of electric motors.

4. The taxiing system of claim 3 wherein the plurality of switches is configured to change flow of electric energy within the taxiing system to perform at least one of moving the aircraft using the number of electric motors, braking the aircraft using the taxiing system, or storing electric energy in at least one of the energy storage locations.

5. The taxiing system of claim 2, wherein the control system is configured to direct electric energy generated by the number of electric motors to at least one battery of the number of batteries.

6. The taxiing system of claim 5, wherein the control system is configured to direct electric energy generated by the number of electric motors to at least one of an engine of the number of engines of the aircraft or an auxiliary power unit of the number of auxiliary power units when the battery reaches a charge capacity.

7. The taxiing system of claim 1, wherein the number of engines of the aircraft is configured to receive electric energy from the number of electric motors and rotate components of the number of engines using the electric energy.

8. The taxiing system of claim 1, wherein the number of auxiliary power units is configured to receive electric energy from the number of electric motors and rotate components of the number of auxiliary power units using the electric energy.

9. An aircraft comprising:
carbon brakes;
engines;
landing gear having wheels; and
a taxiing system configured to propel and decelerate motion of the aircraft, the taxiing system comprising energy storage locations electrically connected to a number of electric motors, the energy storage locations including at least two of a number of engines of the aircraft, a number of batteries, and a number of auxiliary power units of the aircraft, and the number of electric motors connected to wheels of the aircraft to at least one of decelerate the wheels by transferring kinetic energy of the aircraft into electric energy or drive the wheels using electric energy provided by at least one energy storage location of the energy storage locations.

10. The aircraft of claim 9 further comprising:
a control system configured to send commands to a flow control switch system to direct electric energy between the energy storage locations and the number of electric motors.

11. The aircraft of claim 10 further comprising:
the flow control switch system comprising a plurality of switches configured to direct electric energy between the energy storage locations and the number of electric motors.

12. The aircraft of claim 9, wherein an engine of the number of engines further comprises a motor connected to a core of the engine and a second motor connected to a fan of the engine, wherein the motor is configured to receive electrical power from the number of electric motors connected to the wheels to absorb energy in the core of the engine, and wherein the second motor is configured to receive electrical power from the number of electric motors connected to the wheels.

13. The taxiing system of claim 9, wherein the number of engines of the aircraft is configured to receive electric energy from the number of electric motors.

14. The taxiing system of claim 9, wherein the number of auxiliary power units is configured to receive electric energy from the number of electric motors.

15. A method of taxiing an aircraft comprising:
directing electric energy from an energy storage location of energy storage locations selected from one of an engine of the aircraft, an auxiliary power unit, or a battery to an electric motor to generate kinetic energy;
driving wheels of the aircraft using the kinetic energy generated by the electric motor; and
decelerating movement of the aircraft by transferring the kinetic energy of the aircraft into electric energy by operating the electric motor as electric motor brakes of a taxiing system of the aircraft.

16. The method of claim 15, wherein movement of the aircraft is decelerated by applying electric motor brakes up to a threshold force.

17. The method of claim 15 further comprising:
directing excess electric energy generated by decelerating movement of the aircraft using the electric motor to at least one of the energy storage locations.

18. A method of taxiing an aircraft comprises:
harvesting energy from landing an aircraft by a number of electric motors connected to landing gear of the aircraft;
sending the energy harvested from landing the aircraft to an engine core of the aircraft and converting the energy to kinetic energy; and
taxiing the aircraft by sending electric energy generated by extracting the kinetic energy from the engine core to the number of electric motors.

19. The method of claim 18 further comprising:
decelerating movement of the aircraft using the number of electric motors acting as electric motor brakes of the aircraft.

20. The method of claim 19 wherein movement of the aircraft is decelerated by applying the electric motor brakes up to a threshold force.

21. A method of powering auxiliary systems of an aircraft comprising:
harvesting energy from landing an aircraft by a number of electric motors connected to landing gear of the aircraft;
sending the energy harvested from landing the aircraft to an auxiliary power unit of the aircraft; and
powering auxiliary operations by the auxiliary power unit using the energy.
